(19) United States
(12) Patent Application Publication
(10) Pub. No.: US 2022/0136859 A1
(43) Pub. Date: May 5, 2022

(54) APPARATUS AND METHOD FOR UPDATING MAP

(71) Applicant: TOYOTA JIDOSHA KABUSHIKI KAISHA, Toyota-shi (JP)

(72) Inventor: Masahiro TANAKA, Tokyo-to (JP)

(21) Appl. No.: 17/498,040

(22) Filed: Oct. 11, 2021

(30) Foreign Application Priority Data
Nov. 5, 2020 (JP) 2020-184917

(51) Int. Cl. G01C 21/00; G01C 21/32

(52) U.S. Cl. CPC G01C 21/3822; G01C 21/32; G01C 21/387; G01C 21/3833

(57) ABSTRACT

An apparatus for updating a map includes a communication interface configured to receive pieces of reliability information indicating degrees of reliability from a vehicle, the degrees of reliability each indicating how likely a feature at a first location is represented in an image obtained by a camera mounted on the vehicle; and a processor configured to determine that the feature at the first location is removed, when a ratio of the number of pieces of reliability information indicating the degrees of reliability less than a second threshold to the total number of received pieces of reliability information is not less than a predetermined ratio threshold, the second threshold being less than a first threshold for determining that the feature is detected, and update a map so as to delete information on the feature at the first location from the map when it is determined that the feature is removed.

### FIELD

The present invention relates to an apparatus and a method for updating a map.

### BACKGROUND

Highly accurate road maps to which an automated vehicle-driving system refers for automated driving control of a vehicle are required to accurately represent road information. Thus techniques have been proposed to appropriately collect road information from multiple vehicles and update a road map, based on the collected information (see, Japanese Unexamined Patent Publications Nos. 2020-71053 and 2020-73893).

In the technique disclosed in Japanese Unexamined Patent Publication No. 2020-71053, an in-vehicle device that executes automated driving control of a vehicle on the basis of map information sets, when a takeover from automated driving control to manual driving occurs, an upload target area including the position of the occurrence and uploads map information on the upload target area to an external device. The external device updates external map information, based on the map information uploaded from the in-vehicle device.

In the technique disclosed in Japanese Unexamined Patent Publication No. 2020-73893, feature information is registered in an advanced map stored in a server device for each feature to be detected by an external sensor of an in-vehicle device. The data structure of the feature information is provided with a field of sensor attributes including setting information or environmental information on detection of features. The server device statistically analyzes conditional information received from multiple in-vehicle devices and indicating conditions at detection of features, thereby updating the field of sensor attributes.

### SUMMARY

In some cases, it is difficult to accurately detect a feature represented in a map with a sensor mounted on a vehicle. In such cases, the feature may not actually exist, and thus it is desirable to appropriately update information on the feature on the map.

It is an object of the present invention to provide an apparatus that can appropriately update information on a feature represented in a map.

According to an embodiment, an apparatus for updating a map is provided. The apparatus includes a communication interface configured to receive pieces of reliability information indicating degrees of reliability from at least one vehicle, the degrees of reliability each indicating how likely a feature at a first location is represented in an image obtained by a camera mounted on the vehicle; and a memory configured to store a map including information on the feature at the first location. The apparatus further includes a processor configured to determine that the feature at the first location is removed, when a ratio of the number of pieces of reliability information indicating the degrees of reliability less than a second threshold to the total number of received pieces of reliability information regarding the first location is not less than a predetermined ratio threshold, the second threshold being less than a first threshold for determining that the feature is detected, and update the map so as to delete the information on the feature at the first location from the map when it is determined that the feature is removed.

In the apparatus, the communication interface preferably further receives, together with each of the pieces of reliability information, position accuracy information indicating the accuracy of the position of the vehicle at the time of acquisition of the image regarding which the degree of reliability included in the piece of reliability information is calculated. The processor does not preferably count the piece of reliability information in calculation of the ratio when the accuracy of the position of the vehicle indicated by the position accuracy information corresponding to the piece of reliability information is lower than a predetermined accuracy.

In the apparatus, the processor preferably determines that there is a cause of decrease in the accuracy of detection of the feature, when the ratio is less than the predetermined ratio threshold and the degree of variations of the degrees of reliability indicated by the pieces of reliability information is not greater than a predetermined variation threshold.

Alternatively, it is preferable that the processor is further configured to transmit to one of the at least one vehicle via the communication interface an image collection instruction to transmit an image representing the first location, when the ratio is less than the predetermined ratio threshold and the degree of variations of the degrees of reliability indicated by the pieces of reliability information is greater than the predetermined variation threshold.

Alternatively, in the apparatus, the communication interface preferably further receives pieces of reliability information indicating degrees of reliability from the at least one vehicle, the degrees of reliability each indicating how likely a feature at a second location is represented in an image obtained by the camera mounted on the vehicle. It is preferable that the processor is further configured to determine that the feature at the second location is newly formed, when a ratio of the number of pieces of reliability information indicating the degrees of reliability not less than a third threshold to the total number of received pieces of reliability information regarding the second location is not less than the predetermined ratio threshold, the third threshold being greater than the first threshold. The processor preferably updates the map so as to add information on the feature newly formed at the second location to the map when it is determined that the feature is newly formed.

According to another embodiment of the present invention, a method for updating a map is provided. The method includes receiving pieces of reliability information indicating degrees of reliability from at least one vehicle, the degrees of reliability each indicating how likely a feature at a first location is represented in an image obtained by a camera mounted on the vehicle; determining that the feature at the first location is removed, when a ratio of the number of pieces of reliability information indicating the degrees of reliability less than a second threshold to the total number of received pieces of reliability information regarding the first location is not less than a predetermined ratio threshold, the second threshold being less than a first threshold for determining that the feature is detected; and updating a map including information on the feature at the first location so as to delete the information on the feature from the map when it is determined that the feature is removed.

The apparatus according to the present invention has an advantageous effect of being able to appropriately update information on a feature represented in a map.

### BRIEF DESCRIPTION OF DRAWINGS

FIG. 1 schematically illustrates the configuration of a map update system including an apparatus for updating a map.

FIG. 2 schematically illustrates the configuration of a vehicle included in the map update system.

FIG. 3 illustrates the hardware configuration of a data acquisition device mounted on the vehicle.

FIG. 4 illustrates the hardware configuration of a server, which is an example of the apparatus for updating a map.

FIG. 5 is a functional block diagram of a processor of the server, related to a map update process.

FIG. 6A illustrates an example of a map representing a feature of interest.

FIG. 6B illustrates an example in which the feature of interest is removed.

FIG. 6C illustrates an example in which there is a cause of decrease in the accuracy of detection of the feature of interest.

FIG. 7 is an operation flowchart of the map update process.

### DESCRIPTION OF EMBODIMENTS

Hereinafter, an apparatus for updating a map and a method therefor executed by the apparatus will be described with reference to the drawings. The apparatus collects pieces of reliability information from a data acquisition device mounted on a vehicle. Each piece of reliability information includes the degree of reliability indicating how likely a feature to be detected is represented in an image generated by a camera of the vehicle, and the type and position of the feature. The data acquisition device mounted on the vehicle calculates the degree of reliability of the feature to be detected, based on an image obtained by the camera mounted on the vehicle. The data acquisition device then generates reliability information including the type, position, and degree of reliability of the feature, and transmits the generated reliability information to the apparatus. Based on the received pieces of reliability information, the apparatus determines, regarding a location in a map where a certain feature is represented, whether the feature at this location is removed and whether there is a cause of hindering detection of the feature from the image obtained by the camera mounted on the vehicle.

Examples of the feature to be detected include various signposts, various road markings, traffic lights, and other road features related to travel of vehicles.

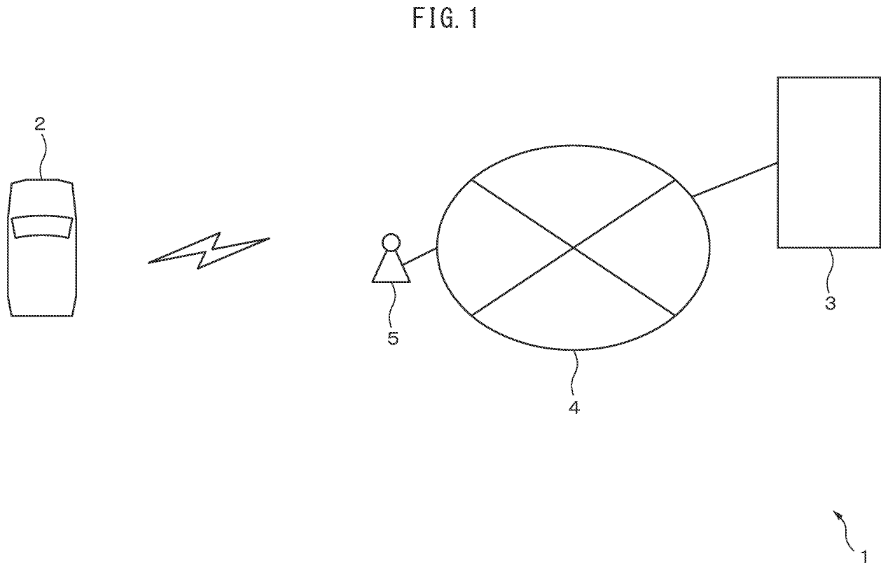

FIG. 1 schematically illustrates the configuration of a map update system including an apparatus for updating a map. In the present embodiment, a map update system 1 includes at least one vehicle 2 and a server 3, which is an example of the apparatus for updating a map. The vehicle 2 accesses a wireless base station 5, which is connected, for example, via a gateway (not illustrated) to a communication network 4 connected with the server 3, thereby connecting to the server 3 via the wireless base station 5 and the communication network 4. Although FIG. 1 illustrates only one vehicle 2, the map update system 1 may include multiple vehicles 2. Similarly, the communication network 4 may be connected with multiple wireless base stations 5.

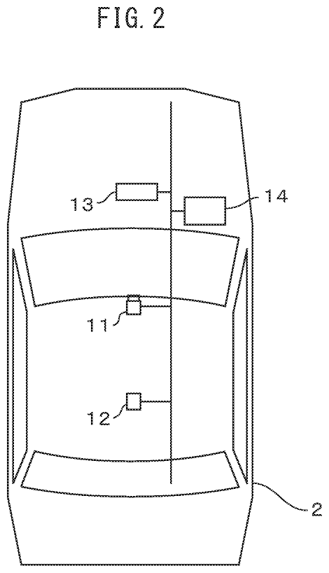

FIG. 2 schematically illustrates the configuration of the vehicle 2. The vehicle 2 includes a camera 11 for capturing surroundings of the vehicle 2, a GPS receiver 12, a wireless communication terminal 13, and a data acquisition device 14. The camera 11, the GPS receiver 12, the wireless communication terminal 13, and the data acquisition device 14 are connected so that they can communicate via an in-vehicle network conforming to a standard, such as a controller area network.

The camera 11, which is an example of an image capturing unit, includes a two-dimensional detector constructed from an array of optoelectronic transducers, such as CCD or C-MOS, having sensitivity to visible light and a focusing optical system for focusing an image of a target region on the two-dimensional detector. The camera 11 is mounted, for example, in the interior of the vehicle 2 so as to be oriented, for example, to the front of the vehicle 2. The camera 11 captures a region in front of the vehicle 2 every predetermined capturing period (e.g., 1/30 to 1/10 seconds), and generates images of this region. The images obtained by the camera 11 may be color or gray images. The vehicle 2 may include multiple cameras 11 taking pictures in different orientations or having different focal lengths.

Every time the camera 11 generates an image, the camera 11 outputs the generated image to the data acquisition device 14 via the in-vehicle network.

The GPS receiver 12 receives a GPS signal from a GPS satellite at predetermined intervals, and determines the position of the vehicle 2, based on the received GPS signal. The GPS receiver 12 then outputs positioning information indicating the result of determination of the position of the vehicle 2 based on the GPS signal to the data acquisition device 14 via the in-vehicle network at predetermined intervals. The vehicle 2 may include a receiver conforming to a satellite positioning system other than the GPS receiver 12. In this case, this receiver determines the position of the vehicle 2.

The wireless communication terminal 13 is a device to execute a wireless communication process conforming to a predetermined standard of wireless communication, and accesses, for example, the wireless base station 5 to connect to the server 3 via the wireless base station 5 and the communication network 4. The wireless communication terminal 13 generates an uplink radio signal including reliability information or an image received from the data acquisition device 14, and transmits the uplink radio signal to the wireless base station 5 to transmit the reliability information or the image to the server 3. Additionally, the wireless communication terminal 13 receives a downlink radio signal from the wireless base station 5, and passes to the data acquisition device 14 a threshold change instruction or an image upload instruction from the server 3 included in the radio signal.

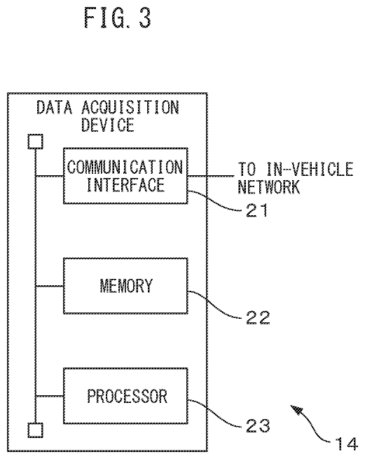

FIG. 3 illustrates the hardware configuration of the data acquisition device. The data acquisition device 14 executes a process related to collection of data for updating a map, including generation of reliability information, based on images generated by the camera 11. To achieve this, the data acquisition device 14 includes a communication interface 21, a memory 22, and a processor 23.

The communication interface 21 includes an interface circuit for connecting the data acquisition device 14 to the in-vehicle network. In other words, the communication interface 21 is connected to the camera 11, the GPS receiver 12, and the wireless communication terminal 13 via the in-vehicle network. Every time it receives an image from the camera 11, the communication interface 21 passes the received image to the processor 23. Every time the communication interface 21 receives positioning information from the GPS receiver 12, the communication interface 21 passes the received positioning information to the processor 23. Additionally, the communication interface 21 outputs reliability information received from the processor 23 to the wireless communication terminal 13 via the in-vehicle network. The communication interface 21 further passes to the processor 23 a threshold change instruction or an image collection instruction received from the server 3 via the wireless communication terminal 13.

The memory 22 includes, for example, volatile and nonvolatile semiconductor memories. The memory 22 may further include other storage, such as a hard disk drive. The memory 22 stores various types of data used in the process related to collection of data for updating a map, which is executed by the processor 23 of the data acquisition device 14. Such data includes, for example, identification information of the vehicle 2; internal parameters of the camera 11, such as the mounted position, orientation, and angle of view of the camera 11; and a set of parameters for specifying a classifier for detecting a feature from an image. The memory 22 may also store images received from the camera 11 and positioning information received from the GPS receiver 12 for a certain period. Additionally, the memory 22 stores a map to be updated. The memory 22 may further store computer programs for various processes executed on the processor 23.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 stores images received from the camera 11 and positioning information received from the GPS receiver 12 in the memory 22. Additionally, the processor 23 executes the process related to collection of data for updating a map during travel of the vehicle 2 at predetermined intervals (e.g., 0.1 to 10 seconds).

As the process related to collection of data for updating a map, for example, the processor 23 calculates the degree of reliability of each feature represented in the map stored in the memory 22 regarding an image received from the camera 11. To this end, the processor 23 identifies the real-space region represented in the image, based on the position and the travel direction of the vehicle 2 at the time of generation of the image and internal parameters of the camera 11, such as its orientation and angle of view, and determines whether the position of a feature represented in the map (hereafter, a “feature of interest”) is included in the identified real-space region. To this end, the processor 23 can use the position indicated by positioning information received from the GPS receiver 12 at the timing closest to the time of generation of the image as the position of the vehicle 2. Alternatively, in the case that an ECU (not illustrated) estimates the position of the vehicle 2, the processor 23 may obtain information indicating the estimated position of the vehicle 2 from the ECU via the communication interface 21. When the position of the feature of interest is included in the real-space region represented in the image, the processor 23 uses the degree of reliability calculated for an area in the image including the position of the feature (hereafter, an “area of interest”) as the degree of reliability of the feature.

For example, the processor 23 inputs the image into a classifier to calculate the degree of reliability of the feature of interest regarding the area of interest in the inputted image (hereafter simply the “input image”). As such a classifier, the processor 23 may use, for example, a deep neural network (DNN) that has been trained to detect from an input image a feature represented in the image. As such a DNN, for example, a DNN having a convolutional neural network (CNN) architecture, such as Single Shot MultiBox Detector (SSD) or Faster R-CNN, is used.

The processor 23 compares the calculated degree of reliability with a predetermined threshold. When the degree of reliability is less than the predetermined threshold, the processor 23 determines that it has failed to detect the feature of interest, and generates reliability information including the degree of reliability and the type and position of the feature. The predetermined threshold is set, for example, to the same value as a detection threshold (first threshold) corresponding to a degree of reliability at which it is determined that the feature exists.

In the case that it has received from the server 3 a threshold change instruction to decrease the threshold, the processor 23 may set the predetermined threshold applied to the real-space region specified by the threshold change instruction to a value less than the detection threshold. In this case, when an image representing the real-space region specified by the threshold change instruction is stored in the memory 22, the processor 23 may calculate the degree of reliability from this image again and compare the calculated degree of reliability with the changed threshold to determine whether to transmit the reliability information to the server 3.

Every time it generates reliability information, the processor 23 outputs the generated reliability information to the wireless communication terminal 13 via the communication interface 21. In this way, the reliability information is transmitted to the server 3.

Additionally, in the case that it has received from the server 3 an image collection instruction to upload an image of a feature at a predetermined position, the processor 23 determines, every time it receives an image from the camera 11, whether the predetermined position is represented in the image. The processor 23 may determine whether the predetermined position is represented in the image, based on the direction from the camera 11, the position and the travel direction of the vehicle 2, and internal parameters of the camera 11, such as its orientation and angle of view. When it is determined that the predetermined position is represented in the image, the processor 23 transmits the image to the server 3 via the communication interface 21 and the wireless communication terminal 13.

The following describes the server 3, which is an example of the apparatus for updating a map.

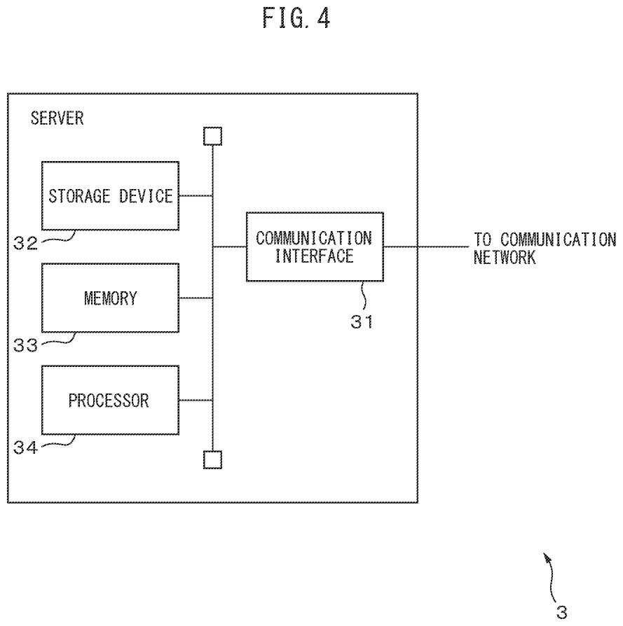

FIG. 4 illustrates the hardware configuration of the server 3, which is an example of the apparatus for updating a map. The server 3 includes a communication interface 31, a storage device 32, a memory 33, and a processor 34. The communication interface 31, the storage device 32, and the memory 33 are connected to the processor 34 via a signal line. The server 3 may further include an input device, such as a keyboard and a mouse, and a display device, such as a liquid crystal display.

The communication interface 31 is an example of the communication unit and includes an interface circuit for connecting the server 3 to the communication network 4. The communication interface 31 is configured so that it can communicate with the vehicle 2 via the communication network 4 and the wireless base station 5. More specifically, the communication interface 31 passes to the processor 34 reliability information received from the vehicle 2 via the wireless base station 5 and the communication network 4.

The storage device 32 is an example of the storage unit and includes, for example, a hard disk drive, or an optical recording medium and an access device therefor. The storage device 32 stores various types of data and information used in a map update process. For example, the storage device 32 stores a map to be updated and a target number of collection of pieces of reliability information. This number serves as a criterion of determination whether to update the map. Additionally, the storage device 32 stores pieces of reliability information received from the vehicle 2. The storage device 32 may further store a computer program executed on the processor 34 for executing the map update process.

The memory 33 is another example of the storage unit and includes, for example, nonvolatile and volatile semiconductor memories. The memory 33 temporarily stores various types of data generated during execution of the map update process.

The processor 34 is an example of a control unit and includes one or more central processing units (CPUs) and a peripheral circuit thereof. The processor 34 may further include another operating circuit, such as a logic-arithmetic unit or an arithmetic unit. The processor 34 executes the map update process.

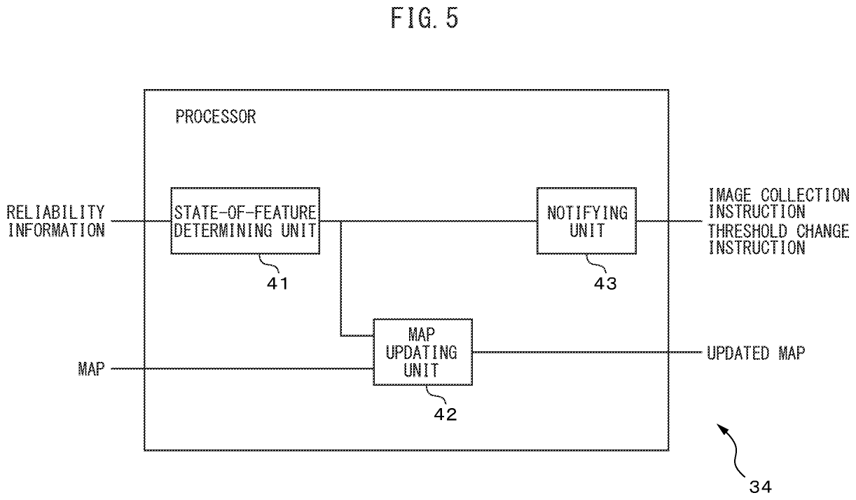

FIG. 5 is a functional block diagram of the processor 34, related to the map update process. The processor 34 includes a state-of-feature determining unit 41, a map updating unit 42, and a notifying unit 43. These units included in the processor 34 are, for example, functional modules implemented by a computer program executed on the processor 34, or may be dedicated operating circuits provided in the processor 34.

The state-of-feature determining unit 41 uses reliability information including the position of a feature of interest (first location) represented in the map and the degree of reliability calculated for a feature of the same type as the feature of interest as reliability information of the feature of interest (hereafter, referred to as “reliability information of interest” for the sake of convenience). Upon receiving pieces of reliability information of interest not fewer than a predetermined target number of collection, the state-of-feature determining unit 41 determines the detection-related state of the feature of interest, based on these pieces of reliability information. Upon receiving one or more pieces of reliability information of the feature of interest, the state-of-feature determining unit 41 may generate a threshold change instruction to decrease the threshold, which is used for comparison with degrees of reliability and serves as a criterion of generation of reliability information, for a predetermined region including the position of the feature of interest and pass it to the notifying unit 43.

The state-of-feature determining unit 41 counts the number of pieces of reliability information of interest including degrees of reliability not greater than a non-detection threshold (second threshold) corresponding to failure of detection of a feature. The non-detection threshold is set to a value less than the detection threshold. When the ratio of this number to the total number of pieces of reliability information of interest is not less than a predetermined ratio threshold (e.g., 0.7 to 0.9), the feature of interest will not be probably detected even if the threshold for feature detection is lowered. In other words, it is supposed that the feature of interest will not be represented in an image captured by the camera 11 of the vehicle 2 whenever the vehicle 2 passes the position where the feature should exist. Hence the state-of-feature determining unit 41 determines that the feature of interest is removed.

When the ratio is less than the predetermined ratio threshold, it is supposed that what appears to be the feature of interest may be represented in some images captured by the camera 11 of the vehicle 2. Thus the state-of-feature determining unit 41 calculates the degree of variations of the degrees of reliability included in the pieces of reliability information of interest. As the degree of variations, the state-of-feature determining unit 41 calculates, for example, the variance of the degrees of reliability or the distance between the first and the third quartiles in the distribution of the degrees of reliability. When the calculated degree of variations is not greater than a predetermined variation threshold, the feature of interest is not accurately detected whenever the vehicle 2 passes the position where the feature should exist. Hence the state-of-feature determining unit 41 determines that there is a cause of decrease in the accuracy of detection of the feature of interest. Causes of decrease in the accuracy of detection include, for example, an obstacle, such as a tree, near the feature of interest covering at least part of the feature, and a stain or breakage of the feature of interest.

When the calculated degree of variations is greater than the predetermined variation threshold, it is supposed that the feature of interest is sometimes detected and sometimes not detected when the vehicle 2 passes the position where the feature should exist. Hence the state-of-feature determining unit 41 determines that there is a certain cause of fluctuations in the accuracy of detection of the feature of interest.

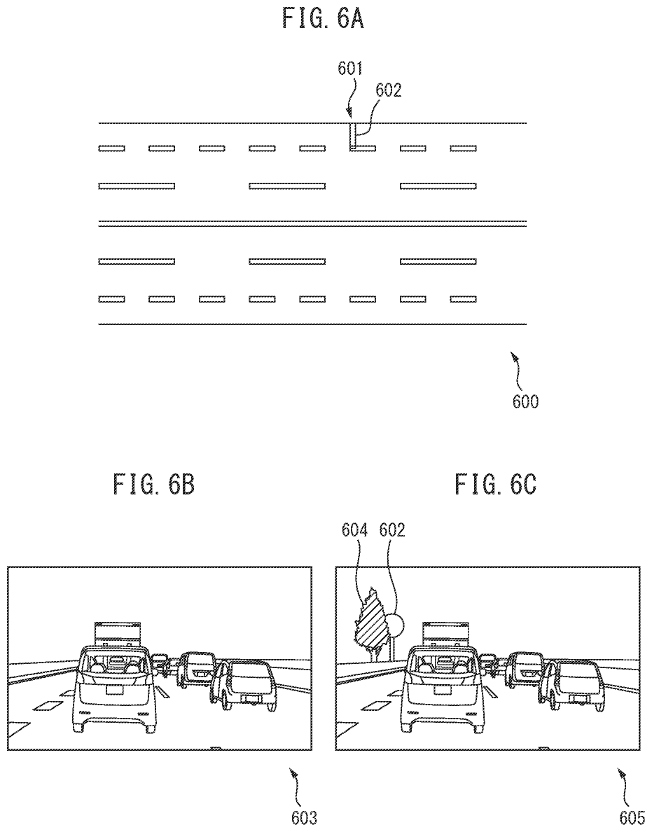

FIG. 6A illustrates an example of a map representing a feature of interest. FIG. 6B illustrates an example in which the feature of interest is removed. FIG. 6C illustrates an example in which there is a cause of decrease in the accuracy of detection of the feature of interest. As illustrated in FIG. 6A, a map 600 represents at a location 601 therein a signpost 602, which is a feature of interest. However, the signpost 602 is removed, and thus not represented in an image 603 of the location 601 illustrated in FIG. 6B as a matter of course. Hence the degree of reliability calculated for the signpost 602 on the basis of the image 603 is always less than the non-detection threshold.

In the example illustrated in FIG. 6C, part of the signpost 602 is covered by a tree 604. As a result, the degree of reliability calculated for the signpost 602 on the basis of an image 605 of the location 601 is greater than the non-detection threshold, but is often less than the detection threshold. Additionally, although part of the signpost 602 is covered, not all the signpost 602 cannot be seen from the camera 11 mounted on the vehicle 2. For this reason, the degree of reliability calculated for the signpost 602 regarding each image obtained whenever the vehicle 2 passes the location 601 is likely to be a somewhat high value. This results in the degree of variations of the degrees of reliability being low.

The state-of-feature determining unit 41 outputs the result of determination of the detection-related state of the feature of interest to the map updating unit 42 and the notifying unit 43.

The map updating unit 42 updates a map read from the storage device 32 so as to delete information on a feature of interest from the map, when receiving the result of determination that the feature of interest is removed, as the result of determination of the detection-related state thereof.

The map updating unit 42 may update the map so as to add thereto information indicating that a feature of interest cannot be accurately detected, when receiving the result of determination that there is a cause of decrease in the accuracy of detection of the feature of interest, as the result of determination of the detection-related state thereof.

The notifying unit 43 generates an image collection instruction including the position of a feature of interest specified therein, when receiving the result of determination that there is a cause of fluctuations in the accuracy of detection, as the result of determination of the detection-related state of the feature of interest. The notifying unit 43 transmits the generated image collection instruction to the vehicle 2 via the communication interface 31. In the case that the map update system 1 includes multiple vehicles 2, the notifying unit 43 may transmit the image collection instruction to all or only some of the vehicles 2. For example, in the case that the server 3 receives from each vehicle 2 the current position of the vehicle 2 at predetermined intervals, the notifying unit 43 may identify vehicles 2 within a predetermined area of the position of a feature of interest, based on the latest current position of each vehicle 2, and transmit the image collection instruction only to the identified vehicles 2.

Upon receiving a threshold change instruction from the state-of-feature determining unit 41, the notifying unit 43 transmits the threshold change instruction to the vehicle 2 via the communication interface 31. Additionally, the notifying unit 43 may transmit the updated map to the vehicle 2 via the communication interface 31.

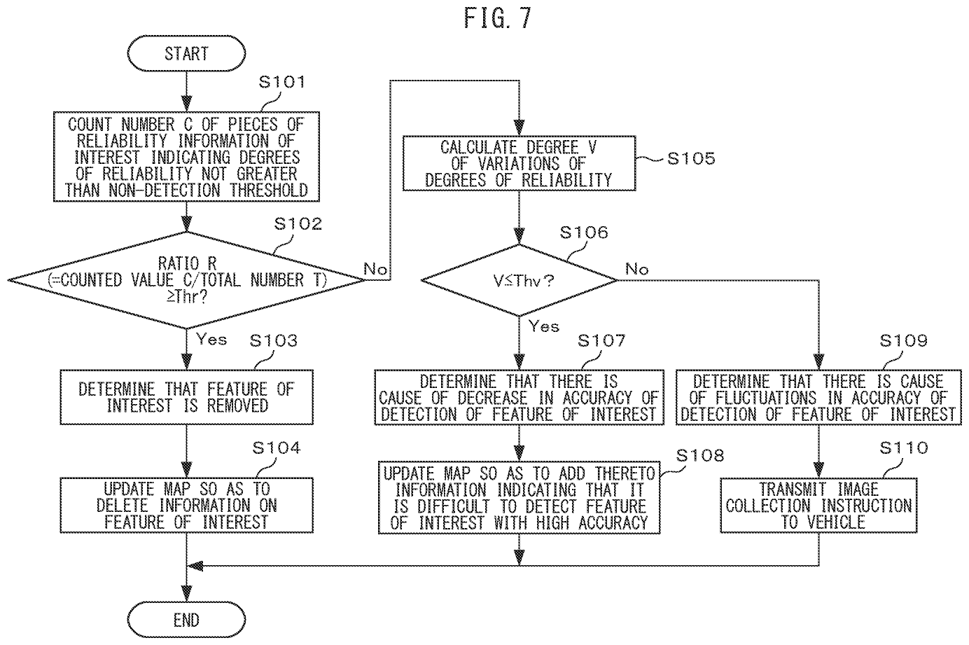

FIG. 7 is an operation flowchart of the map update process in the server 3. The processor 34 of the server 3 may execute the map update process in accordance with the following operation flowchart regarding a feature of interest, when the number of pieces of reliability information of the feature of interest received from the vehicle 2 reaches the predetermined target number of collection.

The state-of-feature determining unit 41 of the processor 34 counts the number C of pieces of reliability information of interest including degrees of reliability not greater than the non-detection threshold (step S101). The state-of-feature determining unit 41 then determines whether the ratio R of the number C of pieces of reliability information of interest indicating degrees of reliability not greater than the non-detection threshold to the total number T of received pieces of reliability information of interest is not less than the predetermined ratio threshold Thr (step S102).

When the ratio R is not less than the ratio threshold Thr (Yes in Step S102), the state-of-feature determining unit 41 determines that the feature of interest is removed (step S103). The map updating unit 42 of the processor 34 then updates a map so as to delete information on the feature of interest from the map (step S104).

When the ratio R is less than the ratio threshold Thr (No in Step S102), the state-of-feature determining unit 41 calculates the degree V of variations of the degrees of reliability included in the pieces of reliability information of interest (step S105). The state-of-feature determining unit 41 then determines whether the calculated degree V of variations is not greater than the predetermined variation threshold Thv (step S106).

When the degree V of variations is not greater than the variation threshold Thv (Yes in Step S106), the state-of-feature determining unit 41 determines that there is a cause of decrease in the accuracy of detection of the feature of interest (step S107). The map updating unit 42 then updates a map so as to add thereto information indicating that the feature of interest cannot be accurately detected (step S108).

When the degree V of variations is greater than the variation threshold Thv (No in Step S106), the state-of-feature determining unit 41 determines that there is a cause of fluctuations in the accuracy of detection of the feature of interest (step S109). The notifying unit 43 of the processor 34 then transmits an image collection instruction including the position of the feature of interest specified therein to the vehicle 2 via the communication interface 31 (step S110).

After step S104, S108, or S110, the processor 34 terminates the map update process.

As has been described above, the apparatus for updating a map judges the state of a feature at a predetermined location, including removal thereof, depending on the distribution of degrees of reliability each indicating how likely the feature is represented in an image obtained by an image capturing unit mounted on a vehicle. For this reason, the apparatus can appropriately judge the detection-related state of the feature, and thus appropriately update information on the feature included in a map.

According to a modified example, the apparatus may update a map so as to add thereto information on a feature (e.g., the type and location thereof) that is not represented in the map when the feature is detected from an image generated by the camera 11 of the vehicle 2.

In this case, when the degree of reliability calculated for the feature that is not represented in the map is greater than a predetermined threshold, the processor 23 of the data acquisition device 14 mounted on the vehicle 2 generates reliability information including the degree of reliability and the type and position of the feature. The processor 23 may identify the real-space position corresponding to an area where the degree of reliability is greater than the predetermined threshold, based on the centroid position of the area, the position and the travel direction of the vehicle 2 at the timing of generation of the image including this area, and internal parameters of the camera 11, such as its orientation and angle of view. When no feature of the type having a degree of reliability greater than the predetermined threshold is represented at the identified position in the map, the processor 23 determines that the feature is not represented in the map. The processor 23 then outputs the generated reliability information via the communication interface 21 to the wireless communication terminal 13 to transmit the reliability information to the server 3. In the case that it has received from the server 3 a threshold change instruction to increase the threshold, the processor 23 may set the predetermined threshold applied to the real-space region specified by the threshold change instruction to a value greater than the detection threshold.

Contrary to the embodiment, the state-of-feature determining unit 41 of the processor 34 of the server 3 counts the number of pieces of reliability information of interest including degrees of reliability not less than a predetermined threshold (third threshold), which is greater than the detection threshold, of the received pieces of reliability information of interest of a feature of interest at a position of interest (second location) not fewer than a predetermined target number of collection. When the ratio of this number to the total number of pieces of reliability information of interest is not less than the predetermined ratio threshold, the feature of interest will be almost certainly detected even if the threshold for feature detection is raised. Hence the state-of-feature determining unit 41 determines that the feature of interest is newly formed. The map updating unit 42 of the processor 34 updates the map so as to include information on the feature of interest at the corresponding position of the feature.

When the ratio is less than the predetermined ratio threshold, the state-of-feature determining unit 41 calculates the degree of variations of the degrees of reliability included in the pieces of reliability information of interest. When the calculated degree of variations is not greater than the predetermined variation threshold, what appears to be the feature of interest is detected whenever the vehicle 2 passes the corresponding position, but it cannot be said that the feature of interest certainly exists. In this case, the map updating unit 42 does not update the map.

When the calculated degree of variations is greater than the predetermined variation threshold, it is supposed that the feature of interest is sometimes detected and sometimes not detected when the vehicle 2 passes the position where the feature should exist. Hence the state-of-feature determining unit 41 determines that there is a certain cause of fluctuations in the accuracy of detection of the feature of interest. The notifying unit 43 of the processor 23 generates an image collection instruction including the position of the feature of interest specified therein, and transmits the generated image collection instruction to the vehicle 2 via the communication interface 31, as in the embodiment.

According to this modified example, the apparatus can update a map so as to add thereto information on a feature that is not represented in the map.

When the data acquisition device 14 of the vehicle 2 cannot correctly detect the position of the vehicle 2, the real-space region recognized by the data acquisition device 14 and represented in an image generated by the camera 11 may differ from that actually represented in the image. This may result in the data acquisition device 14 failing to detect a feature represented in a map.

Thus, according to another modified example, the server 3 may be configured not to update a map when the accuracy of detection of the position of the vehicle 2 is low.

To achieve this, when transmitting reliability information to the server 3, the data acquisition device 14 may transmit thereto position accuracy information indicating the accuracy of estimation of the position of the vehicle 2 at the time of calculation of the degree of reliability included in the reliability information, together with the reliability information. The position accuracy information may be, for example, the number of satellites from which the GPS receiver 12 mounted on the vehicle 2 has succeeded in receiving GPS signals, an index value indicating the intensity of the received GPS signals, or an index value indicating how likely the received GPS signals are multipath GPS signals.

In this case, when the accuracy of estimation of the position of the vehicle 2 indicated by the position accuracy information is lower than a predetermined position accuracy threshold (i.e., predetermined accuracy), the state-of-feature determining unit 41 of the processor 34 of the server 3 does not use the reliability information received together with the position accuracy information for determination of the detection-related state of a feature of interest. More specifically, the state-of-feature determining unit 41 does not count the piece of reliability information in calculation of the ratio of the number of pieces of reliability information of interest indicating degrees of reliability less than the non-detection threshold to the total number of received pieces of reliability information of interest.

According to this modified example, the server 3 can prevent, from being erroneously used for updating a map, failure of detection of a feature represented in the map that is not caused by the feature but by the accuracy of estimation of the position of the vehicle 2.

According to still another modified example, the data acquisition device 14 of the vehicle 2 may also include, in reliability information transmitted to the server 3, information that may affect the accuracy of detection of a feature, such as the travel direction of the vehicle 2, the time of day of image capture, and the weather at the time of calculation of the degree of reliability. When a feature is not accurately detected, reference to such information makes it easier for the server 3 to identify the reason.

According to yet another modified example, the data acquisition device 14 mounted on the vehicle 2 may be configured not to store a map to be updated. In this case, the processor 23 of the data acquisition device 14 generates reliability information of a feature for which a degree of reliability not less than a predetermined threshold is calculated, and transmits it to the server 3. The predetermined threshold is less than the detection threshold. However, since the degree of reliability of a removed feature is extremely low, this causes reliability information of a removed feature not to be transmitted to the server 3. Thus, for each feature in the region represented in the map to be updated, the state-of-feature determining unit 41 of the processor 34 of the server 3 counts the number of received pieces of reliability information of the feature. Then, for a feature of which the number of pieces of reliability information received in a preceding certain period is less than a predetermined lower-limit threshold, the state-of-feature determining unit 41 generates a compulsory collection instruction to transmit reliability information regarding the position of the feature specified by the instruction regardless of the value of the degree of reliability, and passes the compulsory collection instruction to the notifying unit 43. Upon receiving the compulsory collection instruction, the notifying unit 43 transmits it to the vehicle 2 via the communication interface 31. Upon receiving the compulsory collection instruction, the data acquisition device 14 of the vehicle 2 generates reliability information regarding the position specified by the compulsory collection instruction regardless of the calculated value of the degree of reliability, and transmits it to the server 3. In this way, the server 3 can collect reliability information of a removed feature in the region represented in the map to be updated even if the data acquisition device 14 does not store the map. This eliminates the need for the server 3 to deliver the map to be updated to the vehicle 2, lightening communication load related to delivery of the map.

A computer program for causing a computer to execute processing of the units executed by the processor 34 of the server 3 according to the embodiment or modified examples may be distributed in a form recorded on a semiconductor memory device, a magnetic recording medium, or an optical recording medium.

As described above, those skilled in the art may make various modifications according to embodiments within the scope of the present invention.

What is claimed is:

1. An apparatus for updating a map, comprising:
a communication interface configured to receive pieces of reliability information indicating degrees of reliability from at least one vehicle, the degrees of reliability each indicating how likely a feature at a first location is represented in an image obtained by a camera mounted on the vehicle;
a memory configured to store a map including information on the feature at the first location; and
a processor configured to:
determine that the feature at the first location is removed, when a ratio of the number of pieces of reliability information indicating the degrees of reliability less than a second threshold to the total number of received pieces of reliability information regarding the first location is not less than a predetermined ratio threshold, the second threshold being less than a first threshold for determining that the feature is detected, and
update the map so as to delete the information on the feature at the first location from the map when it is determined that the feature is removed.

2. The apparatus according to claim 1, wherein together with each of the pieces of reliability information, the communication interface further receives position accuracy information indicating the accuracy of the position of the vehicle at the time of acquisition of the image regarding which the degree of reliability included in the piece of reliability information is calculated, and
the processor does not count the piece of reliability information in calculation of the ratio when the accuracy of the position of the vehicle indicated by the position accuracy information corresponding to the piece of reliability information is lower than a predetermined accuracy.

3. The apparatus according to claim 1, wherein the processor determines that there is a cause of decrease in the accuracy of detection of the feature, when the ratio is less than the predetermined ratio threshold and the degree of variations of the degrees of reliability indicated by the pieces of reliability information is not greater than a predetermined variation threshold.

4. The apparatus according to claim 3, wherein the processor is further configured to transmit to one of the at least one vehicle via the communication interface an image collection instruction to transmit an image representing the first location, when the ratio is less than the predetermined ratio threshold and the degree of variations of the degrees of reliability indicated by the pieces of reliability information is greater than the predetermined variation threshold.

5. The apparatus according to claim 1, wherein the communication interface further receives pieces of reliability information indicating degrees of reliability from the at least one vehicle, the degrees of reliability each indicating how likely a feature at a second location is represented in an image obtained by the camera mounted on the vehicle, and
the processor is further configured to determine that the feature at the second location is newly formed, when a ratio of the number of pieces of reliability information indicating the degrees of reliability not less than a third threshold to the total number of received pieces of reliability information regarding the second location is not less than the predetermined ratio threshold, the third threshold being greater than the first threshold, and
the map updating unit updates the map so as to add information on the feature newly formed at the second location to the map when it is determined that the feature is newly formed.

6. A method for updating a map, comprising:
receiving pieces of reliability information indicating degrees of reliability from at least one vehicle, the degrees of reliability each indicating how likely a feature at a first location is represented in an image obtained by a camera mounted on the vehicle;
determining that the feature at the first location is removed, when a ratio of the number of pieces of reliability information indicating the degrees of reliability less than a second threshold to the total number of received pieces of reliability information regarding the first location is not less than a predetermined ratio threshold, the second threshold being less than a first threshold for determining that the feature is detected; and
updating a map including information on the feature at the first location so as to delete the information on the feature from the map when it is determined that the feature is removed.
